(19) United States
(12) Patent Application Publication
(10) Pub. No.: US 2017/0211607 A1
(43) Pub. Date: Jul. 27, 2017

(54) Ball Lock Pin

(71) Applicant: Centrix Aero, LLC, Kent, WA (US)

(72) Inventor: Andres Hernandez, Yorba Linda, CA (US)

(73) Assignee: Centrix Aero, LLC, Kent, WA (US)

(21) Appl. No.: 15/413,003

(22) Filed: Jan. 23, 2017

Related U.S. Application Data
(60) Provisional application No. 62/286,176, filed on Jan. 22, 2016.
(60) Provisional application No. 62/286,211, filed on Jan. 22, 2016.

(51) Int. Cl. F16B 21/16; F16B 5/06

(52) U.S. Cl. CPC F16B 21/165; F16B 5/0642

(57) ABSTRACT

A ball lock pin is provided to avoids the problem of falling balls via machining the retention ring (previously deformed ring) from the inside of the pin body, thus creating a stable and extremely well controlled surface where the steel balls can rest. The pin body does not need to be deformed, thus eliminates any potential corrosion to build up in the area.

### CROSS-REFERENCE TO RELATED APPLICATION

The application claims the benefit under 35 U.S.C. §119(e) of Provisional Application entitled “Ball Lock Pin” Ser. No. 62/286,176, filed on Jan. 22, 2016, and Provisional Application Ser. No. 62/286,211, filed on Jan. 22, 2016, the subject matter of which is incorporated herein by reference in its entirety.

### TECHNICAL FIELD

This description relates generally to temporary fasteners and more specifically to single side temporary fasteners maintaining a clamping force during clamp up processes.

### BACKGROUND

Mechanical fasteners are often configured to provide quick removal. Ball lock pins typically may be used to allow quick removal by depressing a button to remove the ball lock pin. A ball at the end of the ball lock pin pressing against the walls of a receiving cavity is retracted or has an interfering pin removed typically allowing the ball to be pushed back into the body of the ball lock pin, further allowing a user to withdraw the ball lock pin.

Currently manufactured ball lock pins lock elements or bearings or balls tend to “fall” leaving room for improving the device. Conventional or current ball lock pin technology utilizes a set of balls at the end of the pin to secure the pin in position by preventing it to be removed from wherever this pin has been inserted. This is accomplished by a spring loaded inner member that has special cavities or receptacles that accommodate the balls when this inner member is pressed. Once depressed, this inner member retracts, and the balls are pushed out of their receptacles and rest against a deformed ring in the Pin body. This deformed ring is created by a staking tool acting on a cylindrical surface (pin Body) creating an elliptical type stake (deformed ring) in the outer surface of the Pin. This deformed ring disrupts the surface finish exposing the pin core material attracts corrosion, is inconsistent and inaccurate, and it is the cause of the biggest problem these assemblies have: ball loss after installation.

Accordingly, there is a need for removable pin type fasteners that avoid the problem of falling balls.

### SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a ball lock pin that avoids the current technology problem of falling balls via machining the retention ring (previously deformed ring) from the inside of the pin body, thus creating a stable and extremely well controlled surface where the balls can rest. Additionally, the pin body does not need to be deformed after finish, elimination any potential corrosion to build up in the area.

In embodiments, a ball lock pin having a properly designed and machined angled surface from the inside that will precisely control the ball position in open and closed position and movement is provided.

In embodiments, the ball lock pin may have an interchangeable human interface, which makes the pin assembly simpler to manufacture, and potentially lighter as alternative materials can be proposed for this human interface such as high performance plastics.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an incline view of an exemplary ball lock pin.

FIG. 2 is a front view of the exemplary ball lock pin.

FIG. 3 is a sectional view A-A of FIG. 2.

FIG. 4 is a detail view “Detail B” of FIG. 3

FIG. 5 is an alternative detail view “Detail B” of FIG. 3.

Like reference numerals are used to designate like parts in the accompanying drawing.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a ball lock pin. Although the present examples are described and illustrated herein as being implemented in an aircraft system, the system described is provided as an example and not a limitation. As those skilled in the art will appreciate, the present examples are suitable for application in a variety of different types of removable fastening systems.

Conventional or current ball lock pin technology utilizes a set of balls at the end of said pin to secure the pin in position by preventing it to be removed from wherever this pin has been inserted. This is accomplished by a spring loaded inner member that has special cavities or receptacles that accommodate the balls when this inner member is pressed. Once depressed, this inner member retracts, and the balls are pushed out of their receptacles and rest against a deformed ring in the Pin body. This deformed ring is created by a staking tool acting on a cylindrical surface (pin Body) creating an elliptical type stake (deformed ring) in the outer surface of the Pin. This deformed ring attracts corrosion, is inconsistent and inaccurate, and it is the cause of the biggest problem these assemblies have: ball loss after installation.

The present example provides a ball lock pin that avoids the current technology problem of falling balls via machining the retention ring (previously deformed ring) from the inside of the pin body, thus creating a stable and extremely well controlled surface where the balls can rest.

The present description will be better understood from the following detailed description read in light of the accompanying drawings, wherein:

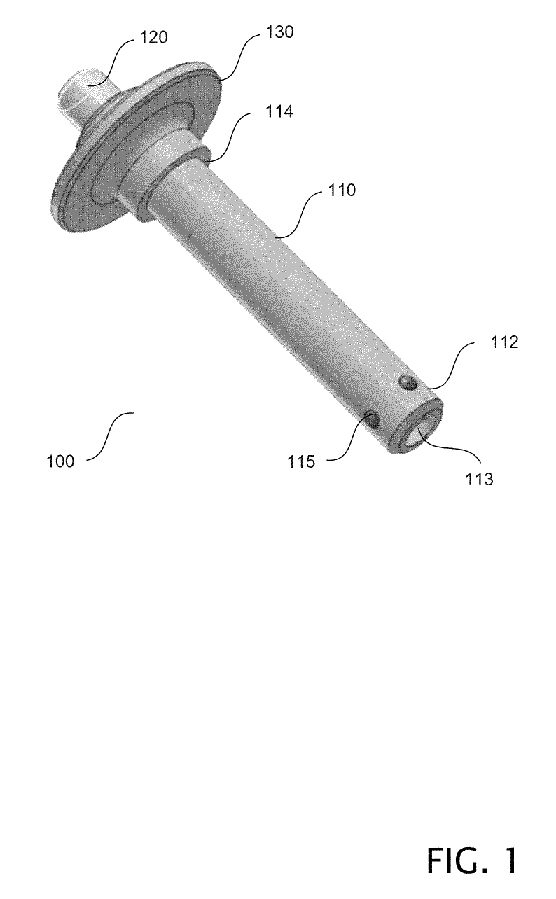

FIGS. 1-5 show various view angles of an exemplary ball lock pin. The ball lock pin 100 comprises a pin body (or an outer shaft) 110 and an inner member (or an inner pin) 120 partially disposed within the outer shaft 110. The outer shaft 110 defines a shaft bore 113 with longitudinal axis between a shaft distal end 112 and a shaft proximal end 114. The shaft bore 113 is sized to accept at least a portion of the inner member 120.

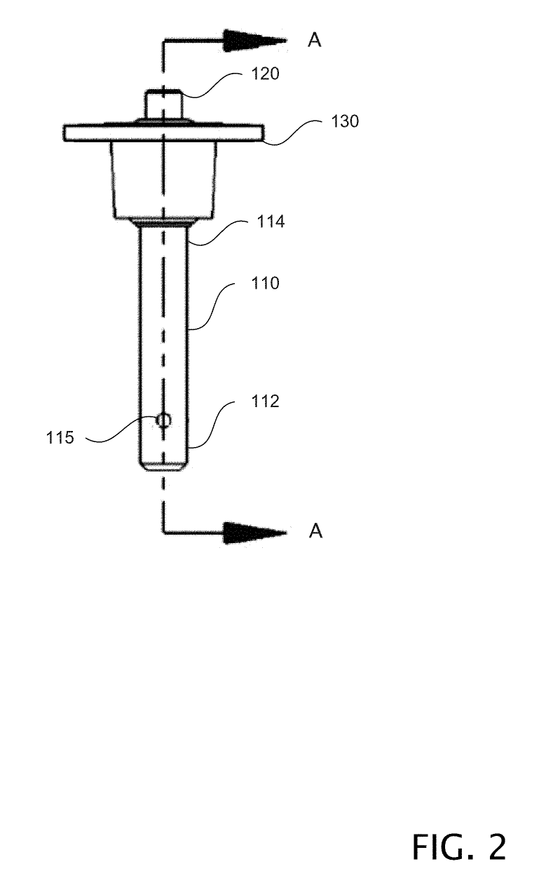

At least one aperture 115 (shown in FIG. 2) is disposed at the shaft distal end 112. The least one aperture 115 is radially outwardly open. The inner member 120 is axially slidable within the outer shaft 110. The inner member 120 has a distal end 122 and a proximal end 124. A groove (or dent) 127 is disposed at the proximal end 124. A locking element, typically a ball 140, is radially displaceable in the aperture 115 between a projected position and a recessed position. In the recessed position, the inner member 120 is positioned to align the groove and the aperture 115, such that the ball 140 is radially recessed within the outer shaft 110. In the projected position, the inner member 120 is positioned to misalign the groove and the aperture 115 such that the ball 140 is pushed radially outward to protrude partially out of the aperture.

In embodiments, the aperture 115 has an opening smaller than the ball 140 such that the ball only protrudes partially out of the aperture and is still securely held by the outer shaft 110 even in the projected position.

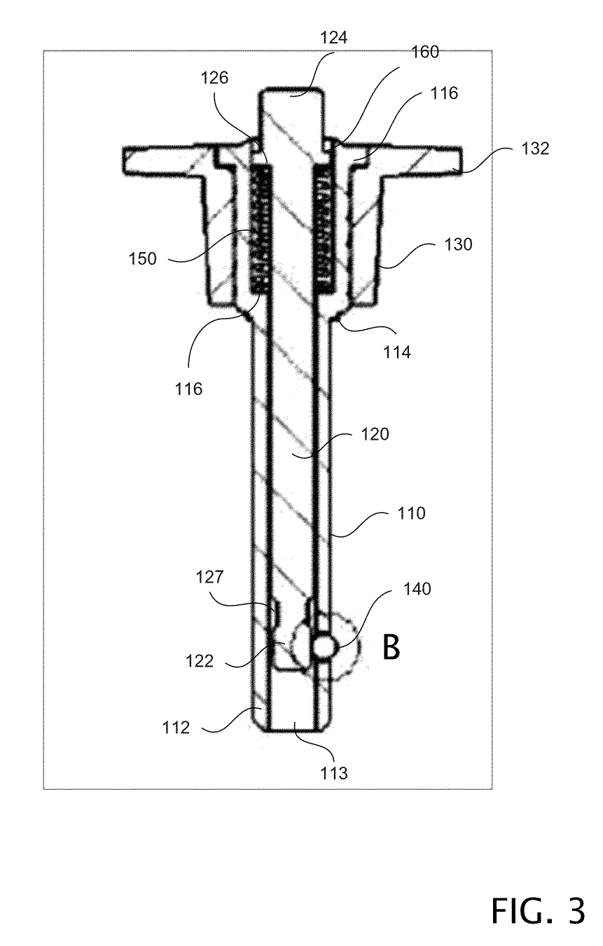

In embodiments, the inner member 120 is biasedly positioned such that the ball 140 is in the projected position by default. The bias position is implemented through a bias element, such as a spring 150 (shown in FIG. 3), placed inside the shaft bore 113 and between a flange 126 disposed at the proximal end 124 and a step 116 within the shaft bore 113. The spring 150 is compressed, when the ball lock pin 100 is assembled, such that the groove 127 and the aperture 115 is misaligned and the ball 140 is in the projected position. When the proximal end 124 is pushed by a user, the spring 150 is compressed further to align the groove and the aperture 115, such that the ball 140 is radially recessed within the outer shaft 110. Placing the spring within the shaft bore prevent mechanical abrasion for the spring and thus promote the durability of the lock pin. In some embodiments, the groove 127 has such a reduced size not only allow the ball 140 radially recessed within the outer shaft 110 when the groove is aligned with the aperture 115, but also allow the ball 115 travelling together with the inner member 120 within the outer shaft 110 to be hidden completely beneath the outer shaft 110, which further protect the ball from any potential mechanical abrasion when the ball is not in the projected position.

Although the embodiment shown in FIG. 1 has a configuration with the inner member biased for projected ball position, one of ordinary skill in the art may understand that the bias position may be configured for recessed ball position.

In embodiments, the inner member 120 is secured by a retention ring 160, which is attached to the outer shaft 110 to prevent the inner member 120 from sliding out of the shaft bore 113. The retention ring 160 may be attached to the outer shaft 110 via thread coupling.

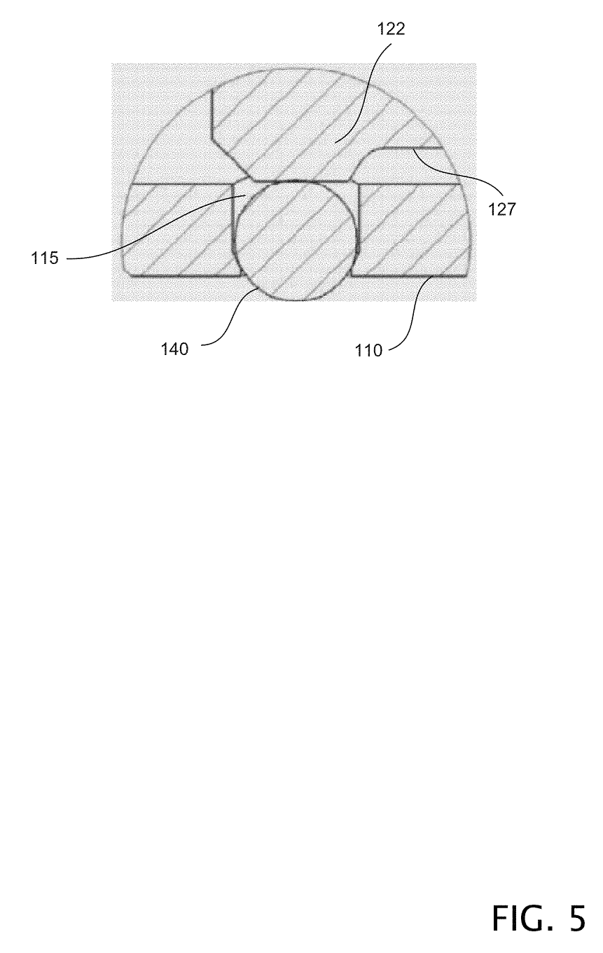

In some embodiments, the aperture 115 has an angled profile, as shown in the sectional view in FIG. 5. The angled profile allows the ball 140 to be projected outward further, compared to straight aperture configuration. For example, the aperture may be machined to be a truncated cone shape with smaller opening outward. The inward opening is larger than the ball while the outward opening is smaller than the ball such that the ball is still securely trapped within the outer shaft 110. Furthermore, the groove 127 has an angled side wall 128 such that when the ball 140 may roll out from the groove gradually and smoothly.

In some embodiments, in order to save weight and fabrication time, an optional large diameter human interface disc 130 may be attached to the outer shaft 110. The human interface disc is a separate component, which can be press or threadly fitted to the outer shaft 110. The human interface disc 130 provides enhanced usability for a user to hold the ball lock pin and press/release the proximal end 124 of the inner member 120. The separate disc can be made out of CRES (Corrosion RESistant steel), if necessary, but it can also be made out of Al alloy, Polyetherimide (such as Ultem 2300), or other plastic for weight savings and to prevent surrounding structure scratches.

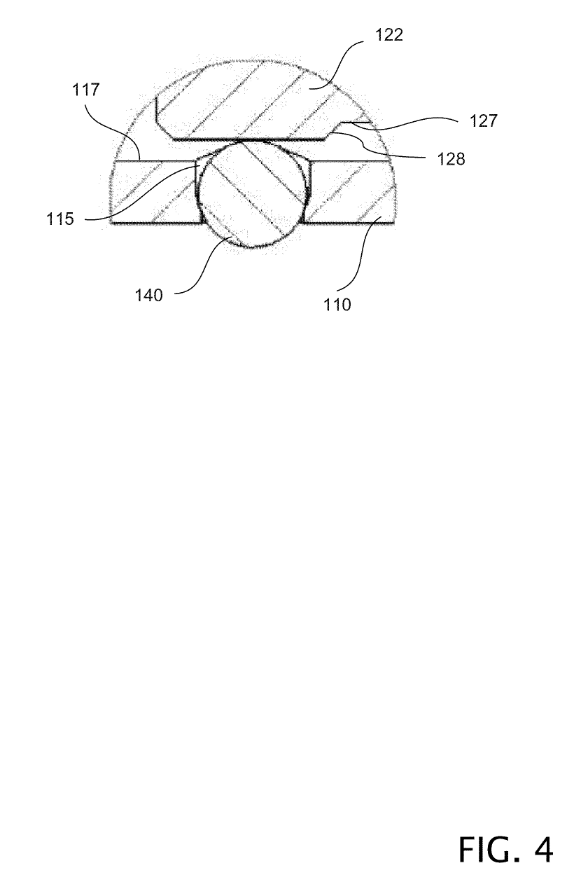

In some embodiments, the inner member 120 has a distal end 122 with reduced size, as shown in FIG. 4, such that the distal end 122 does not touch the interior wall 117 of the outer shaft 110 directly when the inner member 120 slides within the outer shaft 110. The gap between the distal end 122 and the interior wall 117 may provide additional benefits to avoid access wear for the interior wall 117 around the aperture area during the operation of the ball lock pin 100.

Those skilled in the art will realize that the ball lock pin can be constructed with various configurations. For example a ball lock pin may comprise different combination of components other than disclosed in the aforementioned embodiments. Those skilled in the art will also realize that a ball lock pin may further incorporate different components. The foregoing description of the invention has been described for purposes of clarity and understanding. Various modifications may be implemented within the scope and equivalence of the appended claims.

1. A ball lock pin comprising:
an outer shaft having a shaft bore with longitudinal axis between a shaft distal end and a shaft proximal end, the shaft distal end having at least one side apertures;
a ball disposed in the at least one aperture; and
an inner member concentrically disposed within the outer shaft and slidably moving along the shaft bore to enable radially displacement of the ball in the aperture between a projected position and a recessed position, wherein the ball protrudes partially out of the aperture in the projected position, wherein the ball is radially recessed within the outer shaft in the recessed position.

2. The ball lock pin of claim 1 wherein the inner member has a groove disposed in a distal end, the groove being aligned to the at least one aperture for the ball in the recessed position.

3. The ball lock pin of claim 2 wherein the groove has an angled side wall.

4. The ball lock pin of claim 2 wherein the distal end of the inner member has reduced size such that the distal end does not touch an interior wall of the outer shaft.

5. The ball lock pin of claim 1 further comprising a spring disposed within the shaft bore to set the inner member in a biased position.

6. The ball lock pin of claim 5 wherein in the biased position, the ball protrudes partially out of the aperture.

7. The ball lock pin of claim 5 wherein when the spring is compressed further by pushing the inner member toward the shaft proximal end, the ball is radially recessed within the outer shaft.

8. The ball lock pin of claim 5 further comprising a retention ring attached to the outer shaft to prevent the inner member from sliding out of the shaft bore.

9. The ball lock pin of claim 5 wherein the inner member further comprises a flange disposed at a proximal end to contact the spring.

10. The ball lock pin of claim 1 further comprising a human interface disc attached to the outer shaft.

11. A method to control ball movement in a ball lock pin, the method comprising:
disposing an inner pin within a bore of a pin body, the pin body having at least one side-opening apertures disposed on a distal end of the pin body;
disposing a ball in the at least one aperture; and
moving the inner pin within the bore to enable radially movement of the ball in the at least one aperture between a projected position and a recessed position, wherein the ball protrudes partially out of the aperture in the projected position, wherein the ball is radially recessed within the outer shaft in the recessed position.

12. The method of claim 11 wherein the inner pin has a groove disposed in a distal end, wherein the groove is aligned to the at least one aperture for the ball in the recessed position.

13. The method of claim 12 wherein the groove has an angled side wall.

14. The method of claim 12 wherein the distal end of the inner pin has reduced size such that the distal end does not touch an interior wall of the pin body.

15. The method of claim 12 further comprising:
disposing a spring within the bore to set the inner pin in a biased position.

16. The method of claim 15 wherein in the biased position, the ball protrudes partially out of the at least one aperture.

17. The method of claim 15 wherein when the spring is compressed by pushing the inner pin toward the distal end of the pin body, the groove aligns to the at least one aperture such that the ball may be radially recessed within the pin body.

18. The method of claim 15 wherein the spring is compressed against a flange disposed at a proximal end of the inner pin.

19. The method of claim 15 wherein the inner pin is securely retained by a retention ring attached to the outer shaft to prevent the inner pin from sliding out of the bore.

20. The method of claim 11 wherein the at least one aperture has a truncated cone profile with smaller opening outward.
